(19) United States
(12) Patent Application Publication
(10) Pub. No.: US 2025/0073675 A1
(43) Pub. Date: Mar. 6, 2025

(54) ARTICLES COMPOSED OF ANHYDROUS POLYELECTROLYTE COMPLEXES AND THEIR USE AS DRYING AGENTS

(71) Applicant: Florida State University Research Foundation, Inc., Tallahassee, FL (US)

(72) Inventors: Joseph Schlenoff, Tallahassee, FL (US); John Akintola, Tallahassee, FL (US)

(21) Appl. No.: 18/950,254

(22) Filed: Nov. 18, 2024

Related U.S. Application Data
(62) Division of application No. 17/457,370, filed on Dec. 2, 2021.
(60) Provisional application No. 63/120,422, filed on Dec. 2, 2020.

(51) Int. Cl. B01J 20/26; B01D 17/02; B01D 19/00; C08J 3/24; C08K 3/30; C08K 3/34

(52) U.S. Cl. CPC B01J 20/267; B01D 17/0202; B01D 19/0073; C08J 3/246; C08K 3/30; C08K 3/34; B01D 2252/20; B01D 2252/60; C08J 2325/06; C08J 2339/04; C08K 2003/3045

(57) ABSTRACT

Described herein are articles comprising an anhydrous polyelectrolyte complex comprising an interpenetrating network of at least one positively charged polyelectrolyte polymer and at least one negatively charged polyelectrolyte polymer. The articles described herein are effective drying agents with respect to removing water from solvents and gasses. Also described herein are methods for making and using the articles described herein.

### CROSS-REFERENCE TO RELATED APPLICATIONS

This application is a divisional application of U.S. Nonprovisional patent application Ser. No. 17/457,370, filed on Dec. 2, 2021, which claims the benefit of and priority to U.S. Provisional Patent Application No. 63/120,422, filed on Dec. 2, 2020, the contents of each application are incorporated by reference herein in its entirety.

### STATEMENT REGARDING FEDERALLY SPONSORED RESEARCH OR DEVELOPMENT

This invention was made with government support under DMR 1809304 awarded by the National Science Foundation. The government has certain rights in the invention.

### BACKGROUND

Many small-scale and industrial-scale processes require the use of solvents or gases from which water has been removed. Chemical synthesis often requires dry conditions because one of the reagents, intermediates or products may react with water. Water in gases can similarly interfere with reactions and can also be corrosive. Excess humidity is also undesired, especially for systems which cool air for recirculation (air conditioning).

Various drying agents (desiccants) are therefore used to remove as much water as possible from nonaqueous solvents or from gases. These drying agents are preferably cheap, stable, nontoxic, may be regenerated, do not interfere with the reaction, and remove water rapidly without releasing contaminants or particles into the medium they are drying.

Typical drying agents include calcium sulfate (commercially available as Drierite™), molecular sieves, activated aluminum oxide, silica gel, sodium hydroxide, sodium metal, calcium hydride, lithium aluminum hydride, and magnesium sulfate. Some reversibly absorb water and may be regenerated and some react irreversibly with water.

Drying agents which reversibly absorb water may be dried or “reactivated” by heating. For example, calcium sulfate absorbs water of crystallization

CaSO₄₍ₛ₎+1/2H₂O₍ₗ₎→CaSO₄·1/2H₂O₍ₛ₎

The hydrated calcium sulfate may be reactivated by heating at 200-225° C.

Zeolites are porous aluminosilicates which absorb water into molecule-sized cavities. E.g.

K₂Na₂Al₂SiO₇+nH₂O→K₂Na₂Al₂SiO₇·nH₂O

Hydrated zeolites may be reactivated by heating at 300° C. The higher the temperature employed for activation the more energy is used.

However, there is a need for drying agents which efficiently absorb even trace quantities of water, and which can be reactivated at lower temperatures.

### SUMMARY

Described herein are articles comprising an anhydrous polyelectrolyte complex comprising an interpenetrating network of at least one positively charged polyelectrolyte polymer and at least one negatively charged polyelectrolyte polymer. The articles described herein are effective drying agents with respect to removing water from solvents and gasses. Also described herein are methods for making and using the articles described herein.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a thermogram showing the exothermic reaction involved in the hydration of PDADMAC/PSS PEC.

FIG. 2 shows the drying kinetics of all three desiccants (PEC, Drierite, molecular sieves) in ACN (log ppm water versus log time in hours).

FIG. 3 shows the drying kinetics of all three desiccants (PEC, Drierite, molecular sieves) in THF (log ppm water versus log time in hours).

FIG. 4 shows the drying kinetics of all three desiccants (PEC, Drierite, molecular sieves) in toluene (log ppm water versus log time in hours).

FIG. 5 shows the weight versus temperature for a hydrated PDADMA/PSS PEC.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a solvent” include, but are not limited to, mixtures or combinations of two or more such solvents, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein which satisfy the valences of the heteroatoms. This disclosure is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc. It is also contemplated that, in certain aspects, unless expressly indicated to the contrary, individual substituents can be further optionally substituted (i.e., further substituted or unsubstituted).

The term “alkyl” as used herein is a branched or unbranched saturated hydrocarbon group of 1 to 24 carbon atoms, such as methyl, ethyl, n-propyl, isopropyl, n-butyl, isobutyl, s-butyl, t-butyl, n-pentyl, isopentyl, s-pentyl, neopentyl, hexyl, heptyl, octyl, nonyl, decyl, dodecyl, tetradecyl, hexadecyl, eicosyl, tetracosyl, and the like. The alkyl group can be cyclic or acyclic. The alkyl group can be branched or unbranched. The alkyl group can also be substituted or unsubstituted. For example, the alkyl group can be substituted with one or more groups including, but not limited to, alkyl, cycloalkyl, alkoxy, amino, ether, halide, hydroxy, nitro, silyl, sulfo-oxo, or thiol, as described herein. A “lower alkyl” group is an alkyl group containing from one to six (e.g., from one to four) carbon atoms. The term alkyl group can also be a C1 alkyl, C1-C2 alkyl, C1-C3 alkyl, C1-C4 alkyl, C1-C5 alkyl, C1-C6 alkyl, C1-C7 alkyl, C1-C8 alkyl, C1-C9 alkyl, C1-C10 alkyl, and the like up to and including a C1-C24 alkyl.

Throughout the specification “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” or “haloalkyl” specifically refers to an alkyl group that is substituted with one or more halide, e.g., fluorine, chlorine, bromine, or iodine. Alternatively, the term “monohaloalkyl” specifically refers to an alkyl group that is substituted with a single halide, e.g. fluorine, chlorine, bromine, or iodine. The term “polyhaloalkyl” specifically refers to an alkyl group that is independently substituted with two or more halides, i.e. each halide substituent need not be the same halide as another halide substituent, nor do the multiple instances of a halide substituent need to be on the same carbon. The term “alkoxyalkyl” specifically refers to an alkyl group that is substituted with one or more alkoxy groups, as described below. The term “aminoalkyl” specifically refers to an alkyl group that is substituted with one or more amino groups. The term “hydroxyalkyl” specifically refers to an alkyl group that is substituted with one or more hydroxy groups. When “alkyl” is used in one instance and a specific term such as “hydroxyalkyl” is used in another, it is not meant to imply that the term “alkyl” does not also refer to specific terms such as “hydroxyalkyl” and the like.

The term “cycloalkyl” as used herein is a non-aromatic carbon-based ring composed of at least three carbon atoms. Examples of cycloalkyl groups include, but are not limited to, cyclopropyl, cyclobutyl, cyclopentyl, cyclohexyl, norbornyl, and the like. The term “heterocycloalkyl” is a type of cycloalkyl group as defined above, and is included within the meaning of the term “cycloalkyl,” where at least one of the carbon atoms of the ring is replaced with a heteroatom such as, but not limited to, nitrogen, oxygen, sulfur, or phosphorus. The cycloalkyl group and heterocycloalkyl group can be substituted or unsubstituted. The cycloalkyl group and heterocycloalkyl group can be substituted with one or more groups including, but not limited to, alkyl, cycloalkyl, alkoxy, amino, ether, halide, hydroxy, nitro, silyl, sulfo-oxo, or thiol as described herein. In one aspect, the heterocycloalkyl group can be a lactam, including but not limited to an N-substituted lactam.

The term “aryl” as used herein is a group that contains any carbon-based aromatic group including, but not limited to, benzene, naphthalene, phenyl, biphenyl, anthracene, and the like. The aryl group can be substituted or unsubstituted. The aryl group can be substituted with one or more groups including, but not limited to, alkyl, cycloalkyl, alkoxy, alkenyl, cycloalkenyl, alkynyl, cycloalkynyl, aryl, heteroaryl, aldehyde, —NH₂, carboxylic acid, ester, ether, halide, hydroxy, ketone, azide, nitro, silyl, sulfo-oxo, or thiol as described herein. The term “biaryl” is a specific type of aryl group and is included in the definition of “aryl.” In addition, the aryl group can be a single ring structure or comprise multiple ring structures that are either fused ring structures or attached via one or more bridging groups such as a carbon-carbon bond. For example, biaryl to two aryl groups that are bound together via a fused ring structure, as in naphthalene, or are attached via one or more carbon-carbon bonds, as in biphenyl. Fused aryl groups including, but not limited to, indene and naphthalene groups are also contemplated.

The term “heteroaryl” as used herein refers to an aromatic group that has at least one heteroatom incorporated within the ring of the aromatic group. Examples of heteroatoms include, but are not limited to, nitrogen, oxygen, sulfur, and phosphorus, where N-oxides, sulfur oxides, and dioxides are permissible heteroatom substitutions. The heteroaryl group can be substituted or unsubstituted. The heteroaryl group can be substituted with one or more groups including, but not limited to, alkyl, cycloalkyl, alkoxy, amino, ether, halide, hydroxy, nitro, silyl, sulfo-oxo, or thiol as described herein. Heteroaryl groups can be monocyclic, or alternatively fused ring systems. Heteroaryl groups include, but are not limited to, furyl, imidazolyl, pyrimidinyl, tetrazolyl, thienyl, pyridinyl, pyrrolyl, N-methylpyrrolyl, quinolinyl, isoquinolinyl, pyrazolyl, triazolyl, thiazolyl, oxazolyl, isoxazolyl, oxadiazolyl, thiadiazolyl, isothiazolyl, pyridazinyl, pyrazinyl, benzofuranyl, benzodioxolyl, benzothiophenyl, indolyl, indazolyl, benzimidazolyl, imidazopyridinyl, pyrazolopyridinyl, and pyrazolopyrimidinyl. Further not limiting examples of heteroaryl groups include, but are not limited to, pyridinyl, pyridazinyl, pyrimidinyl, pyrazinyl, thiophenyl, pyrazolyl, imidazolyl, benzo[d]oxazolyl, benzo[d]thiazolyl, quinolinyl, quinazolinyl, indazolyl, imidazo[1,2-b]pyridazinyl, imidazo[1,2-a]pyrazinyl, benzo[c][1,2,5]thiadiazolyl, benzo[c][1,2,5]oxadiazolyl, and pyrido[2,3-b]pyrazinyl.

The term “aralkyl” as used herein is an aryl group as defined herein where one or more atoms of the aryl group is substituted with an alkylene group as defined herein. An example of an aralkyl group is a benzyl group (C₆H₅—CH₂—)

The term “halide,” as used herein can be used interchangeably and refer to F⁻, Cl⁻, Br⁻, or I⁻.

The term “carboxylate” as used herein is represented by the formula RC(O)O⁻, where R is an alkyl group, cycloalkyl group, or aryl group as defined above.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

Disclosed are the components to be used to conduct the methods of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

Described herein are articles comprising an anhydrous polyelectrolyte complex comprising an interpenetrating network of at least one positively charged polyelectrolyte polymer and at least one negatively charged polyelectrolyte polymer. The articles described herein are effective drying agents with respect to removing water from solvents and gasses.

The article of the present invention comprises a polyelectrolyte complex, that is, an intermolecular blend of a predominantly positively-charged polyelectrolyte and a predominantly negatively-charged polyelectrolyte. The polyelectrolytes used herein possess multiple electrolytic repeat units that dissociate in solution, which makes the polymer charged.

In one aspect, the anhydrous polyelectrolyte complex used to make the articles described herein is compacted, such as by centrifugation or pressure, in a manner that increases the density of the polyelectrolyte complex to a value substantially greater than that which may be obtained following precipitation. In certain aspects, the article composed of the anhydrous polyelectrolyte complex may be reformed or reshaped to have dimensions typically on the order of micrometers to millimeters to centimeters, which is also substantially greater than that achievable by conventional multilayering and intermixing methods.

In general, the polyelectrolyte complex is formed by combining a predominantly negatively charged polyelectrolyte and a predominantly positively charged polyelectrolyte. In one aspect, the formation of the article starts with combining separate solutions, each containing one of the polyelectrolytes. In this aspect, at least one solution comprises at least one predominantly positively-charged polyelectrolyte, and at least one solution comprises at least one predominantly negatively-charged polyelectrolyte. The formation of a polyelectrolyte complex, Pol⁺ Pol⁻, by mixing individual solutions of the polyelectrolytes in their respective salt forms, Pol⁺ A⁻ and Pol⁻M⁺, may be represented by the following equation:

Pol⁺A⁻+Pol⁻M⁺→Pol⁺Pol⁻+MA

where M⁺ is a salt cation, such as sodium, and A⁻ is a salt anion such as chloride. Pol and Pol⁺ represent repeat units on predominantly negatively charged and predominantly positively charged polyelectrolytes, respectively. According to the equation, the process of complexation releases salt ions into external solution, which are then part of the salt solution concentration.

The precipitates of polyelectrolyte complex, Pol⁺Pol⁻, formed by the reaction above are usually loose with much entrained water. The as-precipitated complex may be rinsed with water to remove salt ions.

Separate solutions containing the polyelectrolytes are combined in a manner that allows the positively-charged polyelectrolyte(s) and the negatively-charged polyelectrolyte(s) to intermix. Intermixing the respective polyelectrolytes causes the in situ formation of a polyelectrolyte complex comprising an intermolecular blend of the positively-charged polyelectrolyte and the negatively-charged polyelectrolyte.

Individual polyelectrolyte solutions that are mixed may themselves comprise mixtures of polyelectrolytes of different chemical composition and/or molecular weight. For example, a solution may comprise two positive polyelectrolytes with two distinct chemical compositions. When the mixture of positive polyelectrolytes is mixed with the negative polyelectrolyte solutions the resulting complex will incorporate a blend of the two positive polyelectrolytes.

### Polyelectrolytes

The charged polymers (i.e., polyelectrolytes) used to form the polyelectrolyte complexes are water and/or organic soluble and comprise one or more monomer repeat units that are positively or negatively charged. The polyelectrolytes used in the present invention may be copolymers that have a combination of charged and/or neutral monomers (e.g., positive and neutral; negative and neutral; positive and negative; or positive, negative, and neutral). Regardless of the exact combination of charged and neutral monomers, a polyelectrolyte of the present invention is predominantly positively charged or predominantly negatively charged and hereinafter is referred to as a “positively charged polyelectrolyte polymer” or a “negatively charged polyelectrolyte polymer,” respectively.

In one aspect, the polyelectrolytes can be described in terms of the average charge per repeat unit in a polymer chain. For example, a copolymer composed of 100 neutral and 300 positively charged repeat units has an average charge of 0.75 (3 out of 4 units, on average, are positively charged). As another example, a copolymer that has 100 neutral, 100 negatively charged, and 300 positively charged repeat units would have an average charge of 0.4 (100 negatively charged units cancel 100 positively charged units leaving 200 positively charged units out of a total of 500 units). Thus, a positively-charged polyelectrolyte has an average charge per repeat unit between 0 and 1 and a negatively-charged polyelectrolyte has an average charge per repeat unit between 0 and −1. An example of a positively-charged copolymer is PDADMA-co-PAC (i.e., poly(diallyldimethylammonium chloride) and polyacrylamide copolymer) in which the PDADMA units have a charge of 1 and the PAC units are neutral so the average charge per repeat unit is less than 1.

In one aspect, the positively-charged polyelectrolyte has an average charge per repeat unit of about 0.1 to 1, or 0.1, 0.15, 0.2, 0.25, 0.3, 0.35, 0.4, 0.15, 0.45, 0.5, 0.55, 0.6, 0.65, 0.7, 0.75, 0.8, 0.85, 0.9, 0.95, or 1.0, where any value can be a lower and upper endpoint of a range (e.g., 0.2 to 0.55). In another aspect, the negatively-charged polyelectrolyte has an average charge per repeat unit of about −0.1 to −1, or −0.1, −0.15, −0.2, −0.25, −0.3, −0.35, −0.4, −0.15, −0.45, −0.5, −0.55, −0.6, −0.65, −0.7, −0.75, −0.8, −0.85, −0.9, −0.95, or −1.0, where any value can be a lower and upper endpoint of a range (e.g., −0.2 to −0.55).

Some polyelectrolytes include equal numbers of positive repeat units and negative repeat units distributed throughout the polymer in a random, alternating, or block sequence. These polyelectrolytes are termed “amphiphilic” polyelectrolytes. For examples, a polyelectrolyte may include 100 randomly distributed styrene sulfonate repeat units (negative) and 100 diallyldimethylammonium chloride repeat units (positive), said molecule having a net charge of zero. These amphiphilic polyelectrolytes also mix on the molecular level and are suitable for this invention. In one aspect, amphiphilic polyelectrolytes used herein include equal numbers of positive and negative repeat units.

In another aspect, the polyelectrolytes include a repeat unit that has both a negative and positive charge. Such repeat units are termed “zwitterionic” and the polyelectrolyte is termed a “zwitterionic polyelectrolyte.” Though zwitterionic repeat units contribute equal number of positive and negative repeat units, the zwitterionic group is still solvated and relatively hydrophilic. An example of a zwitterionic repeat unit is 3-[2-(acrylamido)-ethyldimethyl ammonio] propane sulfonate, AEDAPS. Zwitterionic groups are present on polyelectrolytes as blocks or randomly dispersed throughout the polymer chain. In one aspect, the polyelectrolytes include between about 1% and about 90% zwitterion units, and more preferably said polyelectrolyte comprises between about 10% and about 70% zwitterionic units. In other aspects, the polyelectrolytes having zwitterionic repeat units also include between about 10% and about 90% non-zwitterionic charged repeat units.

The charges on a polyelectrolyte may be derived directly from the monomer units used to make the polyelectrolyte, or they may be introduced by chemical reactions on a precursor polymer. For example, PDADMA is made by polymerizing diallyldimethylammonium chloride, a positively charged water soluble vinyl monomer. PDADMA-co-PAC is made by the polymerization of a mixture of diallyldimethylammonium chloride and acrylamide (a neutral monomer which remains neutral in the polymer). Poly(styrenesulfonic acid) is often made by the sulfonation of neutral polystyrene. Poly(styrenesulfonic acid) can also be made by polymerizing the negatively charged styrene sulfonate monomer. The chemical modification of precursor polymers to produce charged polymers may be incomplete and typically result in an average charge per repeat unit that is less than 1. For example, if only about 80% of the styrene repeat units of polystyrene are sulfonated, the resulting poly(styrenesulfonic acid) has an average charge per repeat unit of about −0.8.

In one aspect, the positively charged polyelectrolyte polymer comprises a plurality of quaternary ammonium groups covalently bonded to the positively charged polyelectrolyte polymer. The term “quaternary ammonium group” is a group bearing a permanently positively charged nitrogen atom, as opposed to an amine, which may be protonated.

In one aspect, the quaternary ammonium group has the structure I

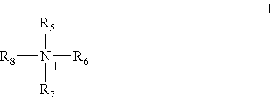

wherein R₅ is an aryl group or an alkylene group and is covalently bonded to the polymer backbone, and R₆, R₇ and R₈ are independently an alkyl group or an aryl group. In one aspect, R₆, R₇ and R⁸ are each a C₁ to C₅ alkyl group. In another aspect, R₆, R₇ and R₈ are each a methyl group.

In one aspect, the quaternary ammonium group comprises a nitrogen-bearing heteroaryl group, wherein nitrogen is alkylated. For example, the heteroaryl group can be a pyridinium group such as a N-methylvinylpyridinium (MVP). In another aspect, the quaternary ammonium group comprises a nitrogen-bearing cycloalkyl group (e.g., a four-to seven-member ring), wherein nitrogen is alkylated. Non-limiting examples of these groups are provided in Table 1.

Exemplary polyelectrolyte repeat units, both positively charged and negatively charged, are shown in Table 1.

TABLE 1
Polyelectrolyte Repeat Units

| Name | Structure |
|---|---|
| diallyldimethylammonium (PDADMA) | 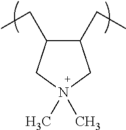 |
| N-methyl-2-vinyl pyridinium (PM2VP) | 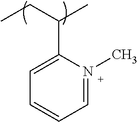 |
| N-methyl-4-vinylpyridinium (PM4VP) | 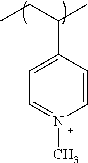 |
| N-octyl-4-vinylpyridinium (PNO4VP) | 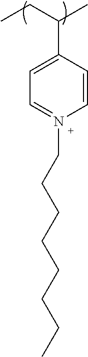 |
| N-methyl-2-vinylpyridinium-co- ethyleneoxide (PM2VP-co-PEO) | 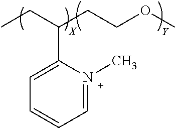 |
| | X and Y denote proportions |
| | of repeat units |
| acrylic acid (PAA) | 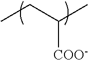 |
| allylamine (PAH) | 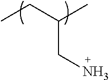 |
| ethyleneimine (PEI) | 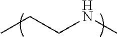 |

Examples of a positively-charged synthetic polyelectrolyte include polyelectrolytes having a quaternary ammonium group, such as poly(diallyldimethylammonium chloride) (PDADMA), poly(vinylbenzyltrimethylammonium) (PVBTA), ionenes, poly(acryloxyethyltrimethyl ammonium chloride), poly(methacryloxy(2-hydroxy)propyltrimethyl ammonium chloride), and copolymers thereof; polyelectrolytes comprising a pyridinium group such as poly(N-methylvinylpyridinium) (PMVP), including poly(N-methyl-2-vinylpyridinium) (PM2VP), other poly(N-alkylvinylpyridines), and copolymers thereof; protonated polyamines such as poly(allylaminehydrochloride) (PAH), polyvinylamine, polyethyleneimine (PEI); polysulfoniums, and polyphosphoniums.

In one aspect, the negatively charged polyelectrolyte polymer comprises a plurality of sulfonate groups, carboxylate groups, phosphate groups, phosphonate groups, or any combination thereof covalently bonded to the negatively charged polyelectrolyte polymer.

Examples of a negatively-charged synthetic polyelectrolyte include polyelectrolytes having a sulfonate group (—SO₃⁻), such as, for example, poly(styrenesulfonic acid) (PSS), poly(2-acrylamido-2-methyl-1-propane sulfonic acid) (PAMPS), sulfonated poly(ether ether ketone) (SPEEK), poly(ethylenesulfonic acid), poly(methacryloxyethylsulfonic acid), their salts, and copolymers thereof; polycarboxylates such as poly(acrylic acid) (PAA) and poly(methacrylic acid), polyphosphates, and polyphosphonates.

Further examples of polyelectrolytes include charged biomacromolecules, which are naturally occurring polyelectrolytes, or synthetically modified charged derivatives of naturally occurring biomacromolecules, such as modified celluloses, chitosan, or guar gum. A positively-charged biomacromolecule usually comprises a protonated sub-unit (e.g., protonated amines). Some negatively charged biomacromolecules comprise a deprotonated sub-unit (e.g., deprotonated carboxylates or phosphates). Examples of biomacromolecules which may be charged for use in accordance with the present invention include proteins, polypeptides, enzymes, DNA, RNA, glycosaminoglycans, alginic acid, chitosan, chitosan sulfate, cellulose sulfate, polysaccharides, dextran sulfate, carrageenin, glycosaminoglycans, sulfonated lignin, and carboxymethylcellulose.

In one aspect, the molecular weight (number average) of synthetic polyelectrolyte molecules is typically about 1,000 to about 5,000,000 grams/mole, or about 10,000 grams/mole to about 1,000,000 grams/mole, or 10,000 grams/mole, 50,000 grams/mole, 100,000 grams/mole, 150,000 grams/mole, 200,000 grams/mole, 250,000 grams/mole, 300,000 grams/mole, 350,000 grams/mole, 400,000 grams/mole, 450,000 grams/mole, 500,000 grams/mole, 550,000 grams/mole, 600,000 grams/mole, 650,000 grams/mole, 700,000 grams/mole, 750,000 grams/mole, 800,000 grams/mole, 850,000 grams/mole, 900,000 grams/mole, 950,000 grams/mole, or 1,000,000 grams/mole, where any value can be a lower or upper endpoint of a range (e.g., 450,000 grams/mole to 800,000 grams/mole). The molecular weight of naturally occurring polyelectrolyte molecules (i.e., biomacromolecules), however, can reach as high as 10,000,000 grams/mole.

Many of the polyelectrolytes useful herein, such as PDADMA and PEI, exhibit some degree of branching. Branching may occur at random or at regular locations along the backbone of the polymer. Branching may also occur from a central point and in such a case the polymer is referred to as a “star” polymer, if generally linear strands of polymer emanate from the central point. If, however, branching continues to propagate away from the central point, the polymer is referred to as a “dendritic” polymer. Branched polyelectrolytes, including star polymers, comb polymers, graft polymers, and dendritic polymers, are also suitable for purposes of this invention. Block polyelectrolytes, wherein a macromolecule comprises at least one block of charged repeat units, are also suitable. In one aspect, the number of blocks may be 2 to 5, preferably 2 or 3. In one aspect, if the number of blocks is 3 the block arrangement is ABA.

Many of the foregoing polyelectrolytes have very low toxicity. For example, poly(diallyldimethylammonium chloride), poly(2-acrylamido-2-methyl-1-propane sulfonic acid) and their copolymers are used in the personal care industry, e.g., in shampoos. Also, because some of the polyelectrolytes used in the method of the present invention are synthetic or synthetically modified natural polymers, their properties (e.g., charge density, viscosity, water solubility, and response to pH) may be tailored by adjusting their composition.

Polyelectrolyte solutions used to produce the polyelectrolyte complexes include a solvent. An appropriate solvent is one in which the selected polyelectrolyte is soluble. Thus, the appropriate solvent is dependent upon whether the polyelectrolyte is considered to be hydrophobic or hydrophilic. A hydrophobic polymer displays less favorable interaction energy with water than a hydrophilic polymer. While a hydrophilic polymer is water soluble, a hydrophobic polymer may only be sparingly soluble in water, or, more likely, insoluble in water. Likewise, a hydrophobic polymer is more likely to be soluble in organic solvents than a hydrophilic polymer.

In general, the higher the carbon to charge ratio of the polymer, the more hydrophobic it tends to be. For example, polyvinyl pyridine alkylated with a methyl group (PNMVP) is considered to be hydrophilic, whereas polyvinyl pyridine alkylated with an octyl group (PNOVP) is considered to be hydrophobic. Thus, water is preferably used as the solvent for hydrophilic polyelectrolytes and organic solvents such as ethanol, methanol, dimethylformamide, acetonitrile, carbon tetrachloride, and methylene chloride are preferably used for hydrophobic polyelectrolytes. Even if polyelectrolyte complexes are prepared by mixing organic-soluble and water-soluble polymers, the complex is preferably rinsed to remove organic solvents before it is dried according to the method described herein. Some organic solvents are hard to remove even with extensive rinsing. Therefore, the preferred solvent for polyelectrolyte complexation is water.

Because the target material for sorption is water, in one aspect, the polyelectrolyte complexes described herein are made from hydrophilic repeat units. In another aspect, if any hydrophobic components of the polyelectrolyte complex are included, the finished polyelectrolyte complex does not include more than 10 weight % of non-water-soluble components.

Examples of polyelectrolytes that are soluble in water include, but are not limited to, poly(styrenesulfonic acid), poly(2-acrylamido-2-methyl-1-propane sulfonic acid), sulfonated lignin, poly(ethylenesulfonic acid), poly(methacryloxyethylsulfonic acid), poly(acrylic acids), poly(methacrylic acids), their salts, and copolymers thereof; as well as poly(diallyldimethylammonium chloride), poly(vinylbenzyltrimethylammonium), ionenes, poly(acryloxyethyltrimethyl ammonium chloride), poly(methacryloxy(2-hydroxy)propyltrimethyl ammonium chloride), and copolymers thereof; and polyelectrolytes comprising a pyridinium group, such as, poly(N-methylvinylpyridium), and protonated polyamines, such as, poly(allylamine hydrochloride), polyvinylamine and poly(ethyleneimine).

Some polyelectrolytes include rigid rod backbones, such as aromatic backbones, or partially aromatic backbones, including sulfonated polyparaphenylene, sulfonated polyetherether ketones (SPEEK), sulfonated polysulfones, sulfonated polyarylenes, sulfonated polyarylene sulfones, and polyarylenes comprising alkylammonium groups.

In certain aspects, the charged polyelectrolyte may be a synthetic copolymer comprising pH sensitive repeat units, pH insensitive repeat units, or a combination of pH sensitive repeat units and pH insensitive repeat units. pH insensitive repeat units maintain the same charge over the working pH range of use. The rationale behind such a mixture of pH sensitive groups and pH insensitive groups on the same molecule is that the pH insensitive groups interact with other, oppositely-charged pH insensitive groups on other polymers, holding the polyelectrolyte complex together despite the state of ionization of the pH sensitive groups.

For example, poly(acrylic acids) and derivatives begin to take on a negative charge within the range of about pH 4 to about 6 and are negatively charged at higher PH levels. Below this transition pH range, however, poly(acrylic acids) are protonated (i.e., uncharged). Similarly, polyamines and derivative thereof take on a positive charge if the pH of the solution is below their pKₐ. As such, and in accordance with the present invention, the pH of a polyelectrolyte solution may be adjusted by the addition of an acid and/or base in order to attain, maintain, and/or adjust the electrical charge of a polyelectrolyte at the surface of, or within, a polyelectrolyte complex.

The state of ionization, or average charge per repeat unit, for polyelectrolytes bearing pH sensitive groups depends on the pH of the solution. For example, a polyelectrolyte comprising 100 pH insensitive positively charged units, such as DADMA, and 30 pH sensitive negatively charged units, such as acrylic acid (AA), will have a net charge of +100 at low pH (where the AA units are neutral) and an average of +100/130 charge per repeat unit; and a net charge of +70 at high pH (where 30 ionized AA units cancel out 30 of the positive charges) and an average of +70/130 charge per repeat unit. The different monomer units may be arranged randomly along the polymer chain (“random” copolymer) or they may exist as blocks (“block” copolymer). The average charge per repeat unit is also known as the “charge density.”

pH sensitive polyelectrolyte complexes include pH sensitive polymeric repeat units including moieties such as, for example, carboxylates, pyridines, imidazoles, piperidines, phosphonates, primary, secondary and tertiary amines, and combinations thereof. In one aspect, the polyelectrolytes include copolymers comprising carboxylic acids, such as poly(acrylic acids), poly(methacrylic acids), poly(carboxylic acids), and copolymers thereof. Additional preferred polyelectrolytes comprise protonatable nitrogen atoms, such as poly(pyridines), poly(imidazoles), poly(piperidines), and poly(amines) bearing primary, secondary or tertiary amine groups, such as poly(vinylamines) and poly(allylamine).

To avoid disruption and possible decomposition of the polyelectrolyte complex, polyelectrolytes having pH sensitive repeat units additionally can include pH insensitive charged functionality on the same molecule. In one aspect, the pH insensitive repeat unit is a positively charged repeat unit selected from the group consisting of repeat units containing a quaternary nitrogen atom, a sulfonium (S⁺) atom, or a phosphonium atom. Thus, for example, the quaternary nitrogen may be part of a quaternary ammonium moiety (—N⁺RₐR_{b}R_{c} wherein Rₐ, R_{b}, and R_{c} are independently alkyl, aryl, or mixed alkyl and aryl), a pyridinium moiety, a bipyridinium moiety or an imidazolium moiety, the sulfonium atom may be part of a sulfonium moiety (—S⁺R_{d}Rₑ wherein R_{d} and Rₑ are independently alkyl, aryl, or mixed alkyl and aryl) and the phosphonium atom may be part of a phosphonium moiety (—P⁺R_{f}R_{g}Rₕ wherein R_{f}, R_{g}, and Rₕ are independently alkyl, aryl, or mixed alkyl and aryl). In another embodiment, the pH insensitive repeat unit is a negatively charged repeat unit selected from the group consisting of repeat units containing a sulfonate (—SO₃⁻), a phosphate (—OPO₃⁻), or a sulfate (—SO₄⁻).

Exemplary negatively charged pH insensitive charged repeat units include styrenesulfonic acid, 2-acrylamido-2-methyl-1-propane sulfonic acid, sulfonated lignin, ethylenesulfonic acid, methacryloxyethylsulfonic acid, sulfonated ether ether ketone, phosphate. In one aspect, the pH insensitive negatively charged polyelectrolytes include polyelectrolytes having a sulfonate group (—SO₃⁻), such as poly(styrenesulfonic acid) (PSS), poly(2-acrylamido-2-methyl-1-propane sulfonic acid) (PAMPS), sulfonated poly(ether ether ketone) (SPEEK), sulfonated lignin, poly(ethylenesulfonic acid), poly(methacryloxyethylsulfonic acid), their salts, and copolymers thereof.

Exemplary positively charged pH insensitive repeat units include diallyldimethylammonium, vinylbenzyltrimethylammonium, vinylalkylammoniums, ionenes, acryloxyethyltrimethyl ammonium chloride, methacryloxy(2-hydroxy)propyltrimethyl ammonium, N-methylvinylpyridinium, other N-alkylvinyl pyridiniums, a N-aryl vinyl pyridinium, alkyl-or aryl imidazolium, sulfonium, or phosphonium. Preferred pH insensitive positively-charged polyelectrolytes comprising a quaternary ammonium group, such as poly(diallyldimethylammonium chloride) (PDADMA), poly(vinylbenzyltrimethylammonium) (PVBTA), poly(alkyammoniums), ionenes, poly(acryloxyethyltrimethyl ammonium chloride), poly(methacryloxy(2-hydroxy)propyltrimethyl ammonium chloride), and copolymers thereof; polyelectrolytes comprising a pyridinium group such as poly(N-methylvinylpyridinium) (PMVP), other poly(N-alkylvinylpyridines), and copolymers thereof.

The pH insensitive polyelectrolyte may include a repeat unit that contains protonatable functionality, wherein the functionality has a pKa outside the range of experimental use. For example, poly(allylamine) has protonatable amine functionality with pka in the range 8-10 and is fully charged (protonated) if the experimental conditions do not surpass a pH of about 7.

In one aspect, the pH insensitive groups constitute about 10 mol % to about 100 mol % of the repeat units of the polyelectrolyte, or about 10 mol %, 15 mol %, 20 mol %, 25 mol %, 30 mol %, 35 mol %, 40 mol %, 45 mol %, 50 mol %, 55 mol %, 60 mol %, 65 mol %, 70 mol %, 75 mol %, 80 mol %, 90 mol %, 95 mol %, or 100 mol %, where any value can be a lower or upper endpoint of a range (e.g., 20 mol % to 80 mol %). In one aspect, the pH sensitive groups constitute about 30 mol % to about 70 mol % of the repeat units of the polyelectrolyte.

Optionally, the polyelectrolytes can include an uncharged repeat unit that is not pH sensitive in the operating pH range, for example, about pH 3 to about pH 9. Said uncharged repeat unit is preferably hydrophilic. Examples of uncharged hydrophilic repeat units include, but are not limited to, acrylamide, vinyl pyrrolidone, ethylene oxide, and vinyl caprolactam. The structures of these uncharged repeat units are shown in Table 2. In one aspect, uncharged repeat units also include N-isopropylacrylamide and propylene oxide.

TABLE 2
Neutral Repeat Units

| Name | Structure |
|---|---|
| Acrylamide | 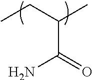 |
| Vinylpyrrolidone | 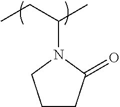 |
| Ethylene oxide | 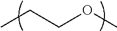 |
| Vinylcaprolactam | 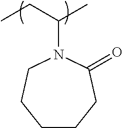 |

In one aspect, the polyelectrolytes include zwitterionic repeat units in the amount of about 10% and about 90% non-zwitterionic charged repeat units. Preferred zwitterionic repeat units are poly(3-[2-(acrylamido)-ethyldimethyl ammonio] propane sulfonate) (PAEDAPS) and poly(N-propane sulfonate-2-vinyl pyridine) (P2PSVP). Examples of other suitable zwitterionic groups are described in U.S. Pat. Pub. No. 20050287111, which is hereby incorporated by reference.

In one aspect, a chemical crosslinking is introduced into the polyelectrolyte complex for stability after deformation. After deformation, for example by extrusion, an article may be treated with a difunctional crosslinking agent, such as XCH₂—φ—CH₂X, where X is a halogen (Cl, Br, or I) and φ is a phenyl group. The phenyl group may be replaced by another aromatic or aliphatic moiety, and easily-displaceable groups, such as toluene sulfonate, may replace the halogen. In one aspect, the crosslinking agent is a dihalogenated compound, such as an aromatic or aliphatic dibromide, which is able to alkylate residual unalkylated units on two adjoining polyelectrolyte chains.

In another aspect, the method of chemical crosslinking a polyelectrolyte complex after straining is heat treatment. For example, amide crosslinks can be formed by heating polyelectrolytes having amine and carboxylic acid groups. In another aspect, a carbodiimide can be added to the polyelectrolytes to activate chemical crosslinking. The level of chemical crosslinking is between about 0.01% and about 50% as measured as a percentage of total ion pairs within the polyelectrolyte complex, or about 0.01%, 0.05%, 0.1%, 0.5%, 1%, 2%, 4%, 6%, 8%, 10%, 15%, 20%, 25%, 30%, 35%, 40%, 45%, or 50%, 8%, where any value can be a lower or upper endpoint of a range (e.g., 0.1% to 10%).

In another aspect, chemical crosslinking of a strained polyelectrolyte complex can be performed by photocrosslinking. Photocrosslinking may be achieved by the light-induced decomposition or transformation of functional groups, such as diarylbenzophenones, that form part of the polymer molecules. In another aspect, photocrosslinking of a polyelectrolyte complex may be accomplished by infusing the reformed polyelectrolyte complex with a small photoactive crosslinker molecule, such as diazidostilbene, then exposing the polyelectrolyte complex to light.

In other aspects, the polyelectrolyte complex includes further physical crosslinks created by hydrogen bonding. Hydrogen bonding is weaker than chemical bonding and occurs between a hydrogen bond donor and a hydrogen bond acceptor. Hydrogen bonds are minimally impacted by the presence of salt and thus the level of physical crosslinking due to hydrogen bonding remains substantially the same as the salt concentration is varied. Accordingly, the polyelectrolyte complex further comprises polymer repeat units capable of hydrogen bonding.

### Preparation of Articles

The articles described composed of the polyelectrolyte complex absorb water

(Pol⁺Pol⁻)⁺nH₂O→(Pol⁺Pol⁻·nH₂O

This water sorption occurs spontaneously in ambient, which means all polyelectrolyte complexes used under ambient conditions contain water. For 50% relative humidity at room temperature the water content of a polyelectrolyte complex nominally termed “dry” may be about 10% by weight. Thus, polyelectrolyte complexes termed “dry” are actually not fully dehydrated in ambient, although they have been removed from contact with water solution and dried.

The anhydrous polyelectrolyte complexes are a water-free material. For the purposes of this invention, an “anhydrous” polyelectrolyte complex is one that contains less than about 1 wt % of water, or about 0%, 0.02%, 0.04%, 0.06%, 0.08%, 0.10%, 0.15%, 0.20%, 0.25%, 0.30%, 0.35%, 0.40%, 0.45%, 0.50%, 0.55%, 0.60%, 0.65%, 0.70%, 0.75%, 0.80%, 0.85%, 0.90%, 0.95%, or less than 1.0 wt %, where any value can be a lower or upper endpoint of a range (e.g., 0.1 wt % to 0.3 wt %).

In one aspect, a solution of at least one positively charged polyelectrolyte polymer and a solution of at least one negatively charged polyelectrolyte polymer are mixed with one another to produce the polyectrolytes complex. In one aspect, the solutions are composed of water. In one aspect, each polyelectrolyte solution is composed of about 0.01 wt % to about 50 wt % by weight of the polyelectrolyte (positive or negative), or about 0.10 wt %, 0.5 wt %, 1 wt %, 5 wt %, 10 wt %, 15 wt %, 20 wt %, 25 wt %, 30 wt %, 35 wt %, 40 wt %, 45 wt %, or 50 wt %, where any value can be a lower or upper endpoint of a range (e.g., 1 wt % to 20 wt %).

The polyelectrolyte complex can be maintained in a fully hydrated state prior to dehydration. In the fully hydrated state, chunks, pellets, pieces or other shapes or articles of the polyelectrolyte complex are fully swollen with water, that is their water content approaches the maximum it would achieve when immersed in water under the conditions of forming. Pieces of the polyelectrolyte complex that are fully hydrated, undoped and wetted by a film of water can be used to produce the anhydrous polyelectrolyte complex. In one aspect, the polyelectrolyte complex can be prepared by coprecipitation of individual polyelectrolytes and maintained in a hydrated state.

The relative amount of the positively charged polyelectrolyte polymer and negatively charged polyelectrolyte polymer used to produce the polyelectrolyte complex can vary. In one aspect, the positively charged polyelectrolyte polymer comprises positive repeat units and the negatively charged polyelectrolyte polymer comprises negative repeat units, wherein the molar ratio of positive repeat units to negative repeat units is from 0.95:1 to 1:0.95. In another aspect, there are stoichiometric amounts of the positive and negative repeat units in the polyelectrolytes. In one aspect, the fully hydrated polyelectrolyte has a glass transition temperature above 25° C. at or above room temperature (20° C. to 25° C.).

In one aspect, the counterions derived from the polyelectrolytes can be removed from hydrated polyelectrolyte complex. In one aspect, the polyelectrolyte complex can be soaked in water to remove the counterions. It is not possible to remove all ions, as some ions remain trapped. However, the existence of trace amounts of ions does not affect the water-removal properties of the anhydrous polyelectrolyte complexes. In one aspect, the counterion includes cations and anions such as alkali metal ions, alkali earth metal ions, halides, sulfates or carboxylates. In one aspect, the counterions are sodium and chloride ions. In one aspect, the ion content of the anhydrous polyelectrolyte complex is less than 1 wt % of the polyelectrolyte complex or about 0 wt %, 0.02 wt %, 0.04 wt %, 0.06 wt %, 0.08 wt %, 0.10 wt %, 0.15 wt %, 0.20 wt %, 0.25 wt %, 0.30 wt %, 0.35 wt %, 0.40 wt %, 0.45 wt %, 0.50 wt %, 0.55 wt %, 0.60 wt %, 0.65 wt %, 0.70 wt %, 0.75 wt %, 0.80 wt %, 0.85 wt %, 0.90 wt %, 0.95 wt %, or less than 1.0 wt %, where any value can be a lower or upper endpoint of a range (e.g., 0.1 wt % to 0.3 wt %).

After the formation of the hydrated polyelectrolyte complex, the complex is heated to remove water and to produce the anhydrous polyelectrolyte complex. In one aspect, the hydrated polyelectrolyte complex is heated at a temperature greater than 100° C. for a sufficient time to produce the anhydrous polyelectrolyte complex. Depending upon the amount of water present in the hydrated polyelectrolyte complex, the temperature and duration of heating can be modified to produce the anhydrous polyelectrolyte complex.

In one aspect, the anhydrous polyelectrolyte complex can be in the form of powders, pellets, fibers, sheets, platelets, coatings or other morphologies designed to maximize the ratio of surface area to volume. The dehydration step can be performed using number of techniques. In one aspect, the hydrated polyelectrolyte complex can be placed in a mold and subsequently heated to produce a shaped article composed of the anhydrous polyelectrolyte complex.

In another aspect, the hydrated polyelectrolyte complex is extruded through an orifice, which defines the shape of the cross section of the reshaped article, such as rod, fiber, tape or tube. Methods known to the art for extruding materials, such as forcing materials through a die or orifice via a piston or a screw, are suitable. The orifice may be of any geometry known to the art, including those geometries that enhance the alignment of high-aspect-ratio fillers during the extrusion step. The orifice and other components are preferably made from corrosion-resistant materials, such as stainless steel, plastic or ceramic. For a screw extruder, a continuous form may be produced as long as pieces of polyelectrolyte complex are fed into the extruder continuously. During extrusion, the hydrated polyelectrolyte complex is heated at a temperature greater than 100° C. to remove water and produce the extruded anhydrous polyelectrolyte complex article. Non-limiting procedures for producing extruded articles are provided in the Examples.

In other aspects, the article can be configured to include two or more different polyelectrolyte complexes. For example, the article can include a first anhydrous polyelectrolyte complex comprising a core comprising a first positively charged polyelectrolyte polymer and a first negatively charged polyelectrolyte polymer, and a shell comprising a second anhydrous polyelectrolyte complex comprising a second positively charged polyelectrolyte polymer or a second negatively charged polyelectrolyte polymer. In one aspect, the hydrated first polyelectrolyte complex can be co-extruded with the hydrated second polyelectrolyte complex such that a fiber or rod is produced having a core/shell structure composed of different anhydrous polyelectrolyte complexes in the core and shell. In one aspect, one of the polyelectrolytes is the same within the core and shell and its oppositely-charged partner is different in the core and shell.

In certain situations, articles composed of the anhydrous polyelectrolyte complex may crack or break or powder when completely dehydrated. In one aspect, the anhydrous polyelectrolyte complex articles that are not powders can be molecularly strained in at least one dimension to provide them with greater toughness. For molecular strain to be stored in an article comprising polyelectrolyte complex the article must first be strained by applying a force. Said force deforms the article, i.e., changes the shape of the article. Various methods to apply mechanical force to deform a sample of polymer are known to the art and include extrusion, compression, extension, bending, twisting, wrapping, spiraling, expanding, and stretching polyelectrolyte complex in one or two dimensions.

The articles described herein have a stored strain. Stored strain is defined as the ratio of an article dimension in the strained dimension, before and after the stored strain is completely released. For example, a rod composed of a polyelectrolyte complex is produced by extrusion. The length of the rod is x cm. The strain is fully released by any of the stimuli described herein and the rod shrinks to a length of y cm (meanwhile, the rod becomes thicker). The stored strain is x/y. In another example, a tube of stored strain polyelectrolyte complex of length m cm is produced by stretching a tube comprising polyelectrolyte complex along the tube length, then drying the tube. When the strain is released by any of the methods described herein the tube shrinks to length n cm. The stored strain is m/n. In another example a tube comprising polyelectrolyte complex is strained in the radial direction to a radius of p cm. When the strain is released by any of the stimuli described herein the radius shrinks to q cm. The stored strain is p/q. The ratios x/y, m/n, p/q may be termed the stored strain factor or the stored strain ratio.

Release of stored strain in a polyelectrolyte complex article as the result of a stimulus is characterized by a decrease in at least one dimension. For example, the stored strain in a rod of strained polyelectrolyte complex may be released by immersion in an aqueous solution of salt (the stimulus), whereupon the rod shortens. In one aspect, the article has a stored strain factor of at least about 2, or about 2, 2.5, 3, 3.5, 4, 4.5, 5, 5.5, 6, 6.5, 7, 7.5, 8, 8.5, 9, 9.5 or 10, where any value can be a lower or upper endpoint of a range (e.g., 2.5 to 5.5).

In one aspect, the stimuli include individually or in combination, heating, solvation (e.g. hydration), a pH change, and doping by a solution comprising salt. In another aspect, the stored stress is not simply released by room temperature hydration.

For sufficient enhancement of materials properties, such as Young's modulus and toughness, and for sufficient response to a stimulus in order to release the stored strain, the preferred stored strain factor is greater than 2, more preferably greater than 3. In one aspect, the article has a stored strain factor of at least about 2, or about 2, 2.5, 3, 3.5, 4, 4.5, 5, 5.5, 6, 6.5, 7, 7.5, 8, 8.5, 9, 9.5 or 10, where any value can be a lower or upper endpoint of a range (e.g., 2.5 to 5.5). For improving mechanical properties such as toughness, the maximum stored strain which may be achieved is preferred.

In one aspect, the molecular orientation created as a result of straining is preserved by chemically crosslinking the polyelectrolyte complex during or after applying a mechanical force. Chemical crosslinking, which forms covalent bonds between polymer molecules, counteracts the effects of the stimulus or other mechanisms which lead to gradual release of the stored strain, and therefore the gradual loss of molecular orientation and therefore to gradual loss of strength (Young's modulus).

Chemical crosslinking that occurs as the stored strain article is being produced by extrusion is an example of reactive extrusion. Reactive extrusion is described in “Reactive Extrusion: Principles and Practice” by M. Xanthos (Oxford Univ. Press, 1992). A preferable reactive group is the anhydride. A preferred reactive extrusion during the forming of a strained polyelectrolyte complex article uses at least one polyelectrolyte comprising at least one of the charged repeat units described recently and an anhydride, and at least one polyelectrolyte comprising a repeat unit that reacts with an anhydride. For example, the first polyelectrolyte comprises styrene sulfonate repeat units and (random or alternating) maleic anhydride repeat units and a second polyelectrolyte comprises amine repeat units. During the reactive extrusion the anhydride reacts with the amine group. Anhydrides tend to be deactivated by water, and thus cannot be stored wet. As an alternative example, reactive extrusion may be performed on a starting polyelectrolyte complex of polyelectrolyte comprising repeat units comprising carboxylate functionality (such as a polyacrylic acid) and polyelectrolyte comprising repeat units comprising amine functionality (such as polyvinylamine or polyallylamine). Heat treating a complex of polycarboxylic acids and polyamines yields amide crosslinks. Other reactive functionalities are suitable for introducing crosslinks, for example wherein the first polyelectrolyte comprises alkenes and the second comprises thiols.

The anhydrous polyelectrolyte complexes also possess good percentage pore volume values that makes them efficient as drying agents. The percentage pore volume is defined as the total volume of all the pores divided by the total volume of the article x 100%. The total percentage pore volume of the article is below at 10%, preferably below about 1%, and even more preferably below about 0.1% of the total volume of the article. In another aspect, total percentage pore volume of the article is 0.01%, 0.02%, 0.03%, 0.04%, 0.05%, 0.06%, 0.07%, 0.08%, 0.09%, 0.1%, 0.5%, 1.0%, 1.5%, 2.0%, 2.5%, 3.0%, 3.5%, 4.0%, 4.5%, 5.0%, 5.5%, 6.0%, 6.5%, 7.0%, 7.5%, 8.0%, 8.5%, 9.0%, 9.5%, or 10.0%, 1.0%, where any value can be a lower or upper endpoint of a range (e.g., 0.02% to 0.09%). If pores are present, they may be elongated due to the strain applied to the article.

### Additives

Solid additives can be incorporated into the polyelectrolyte complex in order to modify the physical properties of the articles described herein. In one aspect, additives which themselves possess desiccant properties can be added to the articles described herein. For example, desiccants such as, for example, calcium sulfate, alumina, silica gel or molecular sieve can be incorporated into the articles with the proviso that the activation temperature for such a desiccant additive is below the decomposition temperature of the anhydrous polyelectrolyte complex base material.

In another aspect, the additives can include fillers and/or reinforcing agents and/or toughening agents, such as inorganic materials such as metal or semimetal oxide particles (e.g., silicon dioxide, aluminum oxide, titanium dioxide, iron oxide, zirconium oxide, and vanadium oxide), clay minerals (e.g., hectorite, kaolin, laponite, attapulgite, montmorillonite), hydroxyapatite or calcium carbonate.

In one aspect, high aspect ratio fillers can be used for stiffening or strengthening the articles described herein at a relatively low fill loading. Examples of high aspect ratio additives include, but are not limited to, metal fibers, inorganic platelets such as calcium carbonate or calcium phosphate (such as hydroxyapatite), needle-like clay minerals, such as attapulgite and halloysite, and carbon-based fibers such as carbon fibers or single or multiwalled carbon nanotubes or graphene. Other high aspect ratio materials having at least one dimension in the 1 nanometer to 100 micrometer range are suitable additives. Such high aspect ratio materials include polymer fibers, such as nylon, aramid, polyolefin, polyester, cotton, and cellulose fibers, as well as cellulose nanofibers. Biodegradable fibers are preferred when the stored strain polyelectrolyte complex article comprises biodegradable polyelectrolytes. The weight % of additives in the polyelectrolyte complex article depends on many factors, such as the aspect ratio and the degree of modification of physical properties required. Accordingly, the solid additives may be between about 1 wt % to about 90 wt % of the polyelectrolyte complex article, or about 1 wt %, 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, or 90 wt %, where any value can be a lower or upper endpoint of a range (e.g., 10 wt % to 50 wt %).

In another aspect, the articles described herein can include magnetic particles having at least one dimension in the size range between 2 nanometers and 100 micrometers that can be manipulated with a magnetic field. For example, the articles described herein with the magnetic particles may be retrieved after use with a larger permanent magnet.

In another aspect, the additives can include dyes that change color according to whether the drying agent is wet or dry, which is referred to as a wet/dry indicator. In this aspect, the relative amount of water absorbed by the anhydrous polyelectrolyte complex in the article can measured or gauged. In one aspect, the amount of the wet/dry indicator present in the anhydrous polyelectrolyte complex is less than 0.1 wt %. Indicator dyes may be inorganic, organic or organometallic. Examples of such dyes include, but are not limited to, cobalt salts and organic dyes such as thymol blue, bromocresol green, phenolphthalein, methyl red, and bromothymol blue.

In one aspect, the additives are added prior to the preparation of the polyelectrolyte complex that is ultimately dehydrated to produce the articles herein. For example, negatively charge additives are can be combined with solutions composed of negatively charged polyelectrolytes prior to mixing with solutions composed of positively charged polyelectrolytes so that the additives and polyelectrolytes do not associate prematurely. In one aspect, the additive(s) and individual polyelectrolytes are thoroughly mixed in solution first under shear flow (as created by stirring or a homogenizer) with the proviso that the shear rate should not be sufficient to break up the polymer chains. In another aspect, if the polyelectrolyte stabilizes and assists in the dispersion of the additive it may be preferable to first mix additive and polyelectrolytes of opposite charge. For example, nanotubes can sometimes be dispersed better in solution if they are “wrapped” with polymers.

In one aspect, additives providing structural properties can be mixed with one of the constituent polyelectrolyte solutions that are used to prepare the polyelectrolyte complex. The advantage of introducing additives prior to the formation of the polyelectrolyte complex is that the additives are incorporated more uniformly throughout the polyelectrolyte complex.

### Applications of the Articles

The articles described herein are effective drying agents. In one aspect, the articles described herein are effective in removing water from a solvent or gas, the method comprising contacting the solvent or gas with the article. For example, the articles described herein can be incorporated into a filter device, where the solvent or gas is passed through the filter. The amount of the article used to remove water can vary depending upon the amount of water to be removed from the gas or solvent. In certain aspects, when a wet/dry indicator has been incorporated into the article, the efficiency of the article for removing water can be monitored. In one aspect, when the article has absorbed water, the article can be heated at a temperature above 100° C. for a sufficient time to regenerate the anhydrous polyelectrolyte complex in the article for future use. In one aspect, regeneration is carried out under reduced pressure (vacuum) or under forced air convection to accelerate the removal of water.

The anhydrous polyelectrolyte complexes described herein have a high affinity for water, which makes them effective as drying agents. One indication of the affinity for water is the enthalpy of hydration, which is the heat released/produced when a anhydrous material is exposed to water. In one aspect, the anhydrous polyelectrolyte complexes possess negative heats of hydration. In one aspect, the anhydrous polyelectrolyte complex has a heat (enthalpy) of hydration of less than 0 kJ per mol. In another aspect, the anhydrous polyelectrolyte complex has a heat (enthalpy) of hydration of less than 0 kJ per mol to −75 kJ per mol, or about −5 kJ per mol, −10 kJ per mol, −15 kJ per mol, −20 kJ per mol, −25 kJ per mol, −30 kJ per mol, −35 kJ per mol, −40 kJ per mol, −45 kJ per mol, −50 kJ per mol, −55 kJ per mol, −60 kJ per mol, −65 kJ per mol, −70 kJ per mol, or −75 kJ per mol, where any value can be a lower or upper endpoint of a range (e.g., −30 kJ per mol to −50 kJ per mol). Non-limiting procedures for determining the heat (enthalpy) of hydration are provided in the Examples.

### ASPECTS

Aspect 1. An article comprising an anhydrous polyelectrolyte complex comprising an interpenetrating network of at least one positively charged polyelectrolyte polymer and at least one negatively charged polyelectrolyte polymer.

Aspect 2. The article of Aspect 1, wherein the positively charged polyelectrolyte polymer comprises a plurality of quaternary ammonium groups covalently bonded to the positively charged polyelectrolyte polymer.

Aspect 3. The article of Aspect 3, wherein the quaternary ammonium group comprises a nitrogen-bearing heteroaryl group, wherein nitrogen is alkylated.

Aspect 4. The article of Aspect 3, wherein the quaternary ammonium group comprises a nitrogen-bearing cycloalkyl group, wherein nitrogen is alkylated.

Aspect 5. The article of Aspect 4, wherein the nitrogen-bearing cycloalkyl group, is a four-to seven-member ring.

Aspect 6. The copolymer of Aspect 3, wherein the quaternary ammonium group has the structure

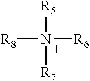

wherein R⁵ is an aryl group or an alkylene group and is covalently bonded to the polymer backbone, and R⁶, R⁷ and R⁸ are independently an alkyl group or an aryl group.

Aspect 7. The article of Aspect 1, wherein the positively charged polyelectrolyte polymer comprises a protonated or alkylated poly(pyridine), a protonated or alkylated poly(imidazole), a protonated or alkylated a poly(piperidine), or a protonated or alkylated poly(amine).

Aspect 8. The article of Aspect 1, wherein the positively charged polyelectrolyte polymer comprises poly(diallyldimethylammonium chloride) (PDADMA), poly(vinylbenzyltrimethylammonium) (PVBTA), ionenes, poly(acryloxyethyltrimethyl ammonium chloride), poly(methacryloxy(2-hydroxy)propyltrimethyl ammonium chloride), and copolymers thereof; polyelectrolytes comprising a pyridinium group such as poly(N-methylvinylpyridinium) (PMVP), including poly(N-methyl-2-vinylpyridinium) (PM2VP), and copolymers thereof; poly(allylaminehydrochloride) (PAH), polyvinylamine, polyethyleneimine (PEI); a polysulfonium, or a polyphosphonium.

Aspect 9. The article of Aspect 1, wherein the positively charged polyelectrolyte polymer comprises poly(diallyldimethylammonium chloride) (PDADMA).

Aspect 10. The article of any one of Aspects 1-9, wherein the positively charged polyelectrolyte polymer has an average positive charge per repeat unit of from 0.1 to 1.0.

Aspect 11. The article of any one of Aspects 1-10, wherein the positively charged polyelectrolyte polymer comprises a copolymer comprising a plurality of positively charged units and a plurality of neutral units.

Aspect 12. The article of any one of Aspects 1-11, wherein the negatively charged polyelectrolyte polymer comprises a plurality of sulfonate groups, carboxylate groups, phosphate groups, phosphonate groups, or any combination thereof covalently bonded to the negatively charged polyelectrolyte polymer.

Aspect 13. The article of any one of Aspects 1-11, wherein the negatively charged polyelectrolyte polymer comprises poly(styrenesulfonic acid) (PSS), poly(2-acrylamido-2-methyl-1-propane sulfonic acid) (PAMPS), sulfonated poly (ether ether ketone) (SPEEK), poly(ethylenesulfonic acid), poly(methacryloxyethylsulfonic acid, or a copolymer or salt thereof; poly(acrylic acid) (PAA), poly(methacrylic acid), or a copolymer or salt thereof; a polyphosphate, or a polyphosphonate.

Aspect 14. The article of Aspect 1 wherein the positively charged polyelectrolyte polymer is poly(diallyldimethylammonium) and the negatively charged polyelectrolyte polymer is poly(styrene sulfonate).

Aspect 15. The article of any one of Aspects 1-14, wherein the positively charged polyelectrolyte polymer and the negatively charged polyelectrolyte polymer has an average molecular weight of from about 1,000 grams/mole to about 5,000,000 grams/mole.

Aspect 16. The article of any one of Aspects 1-15, wherein the positively charged polyelectrolyte polymer and/or the negatively charged polyelectrolyte polymer further comprises a plurality of zwitterionic groups.

Aspect 17. The article of any one of Aspects 1-16, wherein the positively charged polyelectrolyte polymer and the negatively charged polyelectrolyte polymer are crosslinked with one another.

Aspect 18. The article of any one of Aspects 1-17, wherein the negatively charged polyelectrolyte polymer has an average negative charge per repeat unit of from −0.1 to −1.0.

Aspect 19. The article of any one of Aspects 1-18, wherein the positively charged polyelectrolyte polymer comprises positive repeat units and the negatively charged polyelectrolyte polymer comprises negative repeat units, wherein the molar ratio of positive repeat units to negative repeat units is from 0.95:1 to 1:0.95.

Aspect 20. The article of any one of Aspects 1-19, wherein the polyelectrolyte complex comprises a one or more cations and anions.

Aspect 21. The article of Aspect 20, wherein the cations comprise an alkali metal ion or an alkali earth metal ion.

Aspect 22. The article of Aspect 20, wherein the anions comprise a halide, a sulfate or a carboxylate.

Aspect 23. The article of any one of Aspects 20-22, wherein the amount of the one or more cations and anions is less than 1 wt % of the polyelectrolyte complex.

Aspect 24. The article of any one of Aspects 1-23, wherein the polyelectrolyte complex further comprises an inorganic drying agent, a filler, a reinforcing agent, magnetic particles, a wet/dry indicator, or any combination thereof.

Aspect 25. The article of Aspect 24, wherein the inorganic drying agent comprises a molecular sieve, calcium sulfate, silica, alumina, clay, calcium oxide, magnesium oxide, or any combination thereof.

Aspect 26. The article of any one of Aspects 1-25, wherein the article has a stored strain factor of at least about 2.

Aspect 27. The article of any one of Aspects 1-26, wherein when the polyelectrolyte complex is fully hydrated, the article has a glass transition temperature above 25° C. at or above room temperature.

Aspect 28. The article of any one of Aspects 1-27, wherein the anhydrous polyelectrolyte complex has a total percentage pore volume less than 10%.

Aspect 29. The article of any one of Aspects 1-28, wherein the anhydrous polyelectrolyte complex has a heat (enthalpy) of hydration of less than 0 kJ per mol.

Aspect 30. The article of any one of Aspects 1-29, wherein the article is a powder, pellet, fiber, sheet, platelet, or coating.

Aspect 31. The article of any one of Aspects 1-29, wherein the article is a molded article or an extruded article.

Aspect 32. The article of any one of Aspects 1-31, wherein the anhydrous polyelectrolyte complex is crosslinked.

Aspect 33. The article of Aspect 1, wherein the article comprises a first anhydrous polyelectrolyte complex comprising a core comprising a first positively charged polyelectrolyte polymer and a first negatively charged polyelectrolyte polymer, and a shell comprising a second anhydrous polyelectrolyte complex comprising a second positively charged polyelectrolyte polymer or a second negatively charged polyelectrolyte polymer.

Aspect 34. The article of any one of Aspects 1-33, wherein the article is produced by heating a hydrated polyelectrolyte complex comprising an interpenetrating network of at least one positively charged polyelectrolyte polymer and at least one negatively charged polyelectrolyte polymer at a temperature greater than 100° C. for a sufficient time to produce an anhydrous polyelectrolyte complex.

Aspect 35. The article of Aspect 34, wherein the anhydrous polyelectrolyte complex is further crosslinked while the heating the hydrated polyelectrolyte complex.

Aspect 36. The article of Aspect 34, wherein the anhydrous polyelectrolyte complex is treated with a crosslinking agent after heating the hydrated polyelectrolyte complex.

Aspect 37. The article of Aspect 34, wherein the hydrated polyelectrolyte complex is extruded at a temperature greater than 100° C.

Aspect 38. A method for removing water from a solvent or gas, the method comprising contacting the solvent or gas with the article of any one of Aspects 1-37.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure.

Materials and Methods. Poly(diallyldimethylammonium chloride) (PDADMAC, 20 wt % in water, molar mass 400 000-500 000), poly(4-styrenesulfonic acid) (PSS, 18.89 wt % in water, molar mass 75 000), poly(acrylic acid) (PAA, molar mass 240 000), Tris(hydroxymethyl)aminomethane (TRIS) (99.9%, molar mass 121.14), Potassium chloride (99%) and sodium chloride (99.5%) were used as received from Sigma-Aldrich. Poly(vinylbenzyltrimethylammonium chloride) (PVTAC, 26.9 wt % solids in water, molar mass 100 000) and poly(N,N-dimethyl-3,5-dimethylene piperidinium chloride) (PDDPC, molar mass 200 000-300 000, 20% solids in water) were obtained from Scientific Polymer Products. Poly(allylamine) (PAH, molar mass 15 000, Polysciences, Inc.), polyvinylamine (PVA, BASF Lupamin 9095 molar mass 205 000) were all used as received. HPLC grade solvents, toluene (99.9%, Fisher Chemical), tetrahydrofuran (THF, 99.9%, Honeywell), acetonitrile (CAN, 99.9%, Fischer Chemical) were obtained as indicated and further dried through an alumina column. 0.1N Hydrochloric acid was obtained from VWR as used as received. Molecular Sieve, activated, type 3A (8-12 mesh) and Drierite, regular (8 mesh) were obtained from J. T. Baker. Tritiated water (3H) (half-life 12.5 years, β emitter, Eₘₐₓ=18.6 KeV). The stock solution was supplied as 1 mCi in 1 mL of water and used as received from PerkinElmer. EcoLite (+) Liquid Scintillation Cocktail was used as received from MP Biomedicals. All solutions were prepared using 18 MΩ deionized water (Barnstead, E-pure). All polyelectrolyte solutions were 0.125 M based on the repeat unit and further adjusted to pH 7 before use by adding NaOH or HCl.

Polymer Complexation and Extrusion. Complexes were prepared by mixing polycations and polyanions in equal volumes (molar ratio 1:1) under constant stirring for 30 mins at room temperature. Fully hydrated complexes prepared were chopped into chunks between 5 mm and 10 mm were fed, still wet, into a Model LE-075 laboratory extruder (Custom Scientific Instruments). The extrusion was carried out without prior soaking in salt. For PSS/PDADMA complex the extruder parameters were set as follows: rotor temperature, 90° C.; header temperature 115° C.; gap space 3.8 mm; and rotor speed 60% (110 rpm). The extruded fiber-shaped complex was continuously collected on a Model CSI-194T take-up reel rotating at 10 rpm. The parameters allowed the extrusion of fiber at approximately 2 g min⁻¹.

Polymer Stoichiometry. ¹H solution NMR spectroscopy (Bruker Avance 600 MHz was used to determine the stoichiometry i.e. the ratio of PSS to PDADMA in the complex formed. Using paper wipes, a piece of complex (50-100 mg) was collected from prepared complex. This piece removed was then rinsed with 0.25 M NaCl in D₂O (in three different 1 mL aliquots over 24 h) to replace H₂O with D₂O. The precipitates obtained were further redissolved in 2.5 M KBr in D₂O. All protons from component polyelectrolytes were present. Integration of the peaks from the four aromatic hydrogens of PSS (between 5.5 and 9 ppm) was used as an internal standard to compare against the 16 aliphatic ¹H (between 0 and 4.6 ppm). Integration of the peak areas showed the material to be stoichiometric (within a 2% error).

Solution calorimetry. The enthalpies of hydration for the anhydrous polyelectrolyte complex, PEC, systems were determined using a Parr 6755 Solution calorimeter. Finely ground PEC and PE samples were first sieved through a 100 micrometer sieve and loaded into a PTFE dish. Reaction temperatures in the Dewar were precisely measured with a Parr 6772 calorimetric Thermometer. Readings were taken with a thermistor sealed in a stainless-steel probe with a working range from 10 to 50° C.

Solvent Drying. Three solvents were selected to illustrate the efficiency of the anhydrous PEC in removing water. Solvents were first dried with an alumina packed column and 10 mL each was transferred into 20 mL headspace vials with a 20 mm crimp seal air-tight fitted a stopper septum.

Desiccant activation. 1 g of molecular sieve was collected from a sample that was dried to constant weight in vacuum oven kept at 300° C. for 15 hours. Drierite (calcium sulphate) was dried at 220° C. while extruded PECs were activated at 120° C. under vacuum.

TGA. 5 mg of a well-hydrated PEC was dabbed with wipe to remove any excess water and used for TGA analysis using a model Q600 TGA-MS at a heating ramp of 10° C. min⁻¹ from rt to 700° C. The instrument was maintained at isothermal for 3 mins, heating was carried out under argon, and the system equilibrated at 700° C.

Liquid Scintillation Counter Calibration. The efficiency of drying was determined by adding a known concentration of water labeled with tritium to the dry solvent. Drying agents were then added and the water concentration monitored as a function of time.

Calibration in Solvents. Calibration curves were prepared for each set of organic solvent dried with the three desiccants via serial dilution. 10 μl of tritium-labeled water was injected into the 10 ml solvent through the rubber septum into the sealed vial to create a starting water concentration of 1000 ppm. Aliquots were removed at various time intervals, mixed with liquid scintillation counter, and counted in a Charm liquid scintillation counter to obtain water ppm versus time for each combination of solvent/drying agent. Calibration curves obtained in the solvents were used to translate counts per minute (cpm) to residual water content (ppm).

Dust Test. The amount of water contained in dust particles released by the desiccants after a period of drying was investigated. After 3 days of static drying, aliquots counted followed by agitation of the vials to release dust particles after which more aliquot samples were taken. An increase in cpm was observed and a subtraction of this new cpm from the former gives relative amount of dust-associated water (ppm) produced by the desiccants.

Polyelectrolyte Complex Combinations. Polymers were selected for complex formation from commercially available representatives of these common positive and negative repeat units, as summarized below.

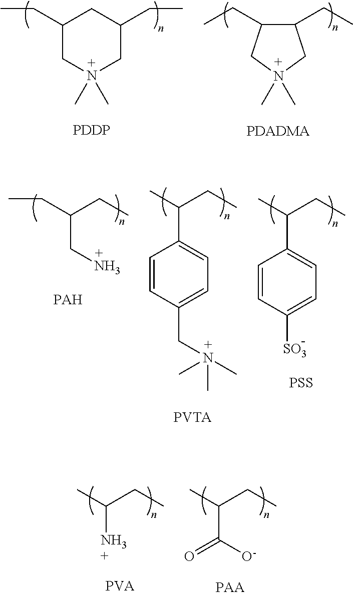

Solutions of PSS and PDADMA were prepared at a concentration of 0.125M with respect to their monomer units, neutralized to pH 7 with NaOH and their ionic strength adjusted (usually to 0.25M NaCl). Typically, 1 L of each was poured simultaneously into a 3 L beaker. 1 L of 0.25 M NaCl, used to rinse the flasks, was added to the precipitate. The mixture was stirred with a magnetic stirrer for about 30 min and the precipitated PEC was decanted and washed with 1 L of 1M NaCl. The PEC was chopped into pieces between 5 mm and 10 mm large then soaked in 1.0 M NaCl for 24 hr.

### Example 1. Enthalpy of Hydration of Anhydrous PEC

To illustrate the affinity of anhydrous PDADMA/PSS PEC for water, a PEC of PDADMA and PSS was activated at 120° C. The anhydrous material was loaded into a sealed sample cell in an inert atmosphere dry box (sealed from ambient conditions) and loaded into the calorimeter.

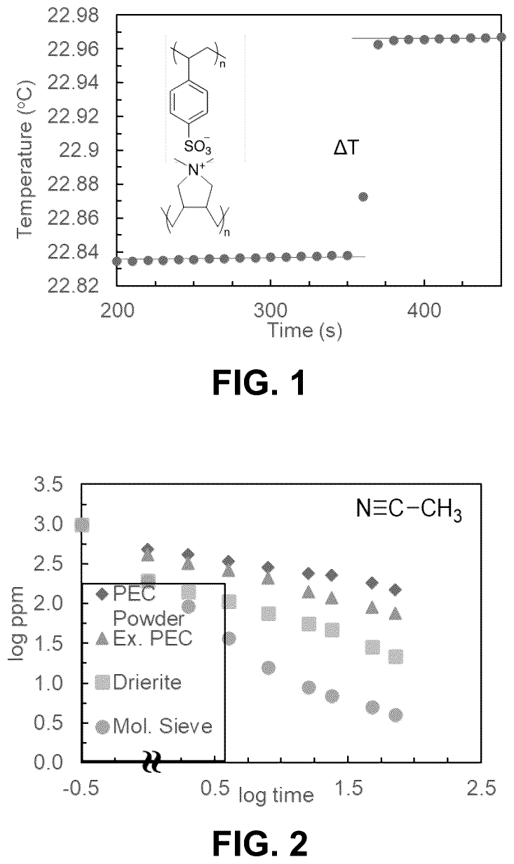

FIG. 1 is a thermogram showing the exothermic reaction involved in the hydration of PDADMAC/PSS PEC. ΔT is calculated by extrapolating to the difference temperature rise during the calorimetry measurements. PEC powder was dried and sieved using a 100 micrometer particle sieve. A. 0.5 g sample was accurately measured inside a glove box into the PTFE dish. The calorimeter was allowed enough time to equilibrate before sample was introduced.

### Example 2. Enthalpy of Hydration of Various Components

The enthalpy of hydration of various anhydrous materials, including anhydrous PDADMA/PSS PEC, was determined from solution calorimetry or from the literature. The more NEGATIVE the enthalpy of hydration the greater SPECIFIC INTERACTIONS of the material with water. It is seen from the Table 3 that PEC formulations PDADMA/PSS, PAA/PAH and PDDP/PSS all have negative enthalpies of hydration and are thus good candidates for drying agents. PECs PVTAC/PSS and PVA/PSS had low enthalpies of hydration and are thus less preferred.

TABLE 3
Enthalpy of hydration of select PECs, individual polyelectrolytes
and comparison drying agents.

| | Mw | Enthalpy/mol | Enthalpy/gram |
|---|---|---|---|
| | (repeat unit) | (kJ mol⁻¹) | (J g⁻¹) |
| PDADMA/PSS | 309 | −43 | −139 |
| PAH/PAA | 129 | −40 | −310 |
| PDDP/PSS | 323 | −36 | −112 |
| Molecular Sieve | 303 | −32 | −105 |
| Calcium Sulphate | 136 | −16 | −118 |
| KCl | 75 | +16 | +215 |
| PSS-Na | 207 | −15 | −73 |
| PDADMAC | 162 | −14 | −86 |
| PVTAC/PSS | 360 | +5 | +14 |
| PVA/PSS | 227 | −3 | −13 |

### Example 3. Comparison of Water Removal From Acetonitrile

The kinetic of water removal from 10 mL acetonitrile with 1000 ppm starting water with anhydrous PDADMA/PSS PEC (powder and fiber), activated calcium sulfate (Drierite) and activated molecular sieve 3A is compared in FIG. 2. 100 μl aliquot samples were removed at each time stamps and injected into a 2 ml liquid scintillation cocktail and counted with a liquid scintillation counter. In this comparison, molecular sieve removes the most water in the time allowed.

### Example 4. Comparison of Water Removal From Tetrahydrofuran (THF)

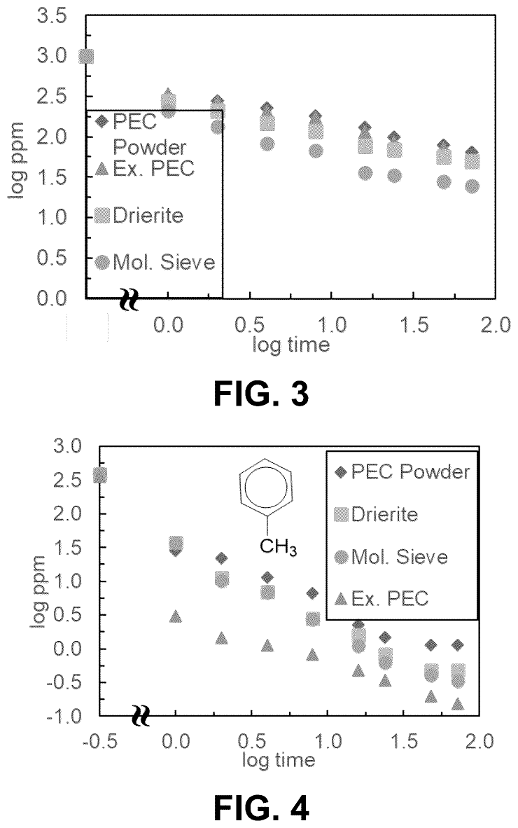

The kinetics of water removal from 10 mL THF with 1000 ppm starting water with anhydrous PDADMA/PSS PEC (powder and fiber), activated calcium sulfate (Drierite) and activated molecular sieve 3A is compared in FIG. 3. In this comparison, molecular sieve removes the most water in the time allowed, but the drying performance of the three desiccants in this medium-polarity solvent is closer.

### Example 5. Comparison of Water Removal From Toluene

The kinetics of water removal from 10 mL toluene with 300 ppm starting water with anhydrous PEC (powder and fiber), activated calcium sulfate (Drierite) and activated molecular sieve 3A is compared in FIG. 4. In this comparison, PEC removes the most water in the time allowed. The difference in drying performance between anhydrous PDADMA/PSS PEC powder and anhydrous PEC fiber shows that the PEC is preferred here.

### Example 6. Drying Summary of Desiccants Including Extended Time

Table 4 illustrates a comparison of residual water content after 1,3 and 14 days using activated PDADMA/PSS PEC, activated calcium sulfate and activated molecular sieve. While the PEC was slower than the conventional drying agents for THF and acetonitrile, it continued to dry these solvents up to 21 days.

TABLE 4

| | Residual Water after 1 | | | Residual Water after 3 | | | Residual Water after 14 | | |
|---|---|---|---|---|---|---|---|---|---|
| | day (ppm) | | | days (ppm) | | | days (ppm) | | |
| Desiccant | ACN | THF | Toluene | ACN | THF | Toluene | ACN | THF | Toluene |
| Mol. Sieve | 7 | 31 | 0.4 | 4 | 23 | 0.3 | — | — | — |
| PEC fiber | 112 | 79 | 0.3 | 79 | 47 | 0.1 | 8 | 9 | 0.06 |
| Drierite | 47 | 63 | 0.5 | 22 | 46 | 0.5 | — | — | — |
| PEC Powder | 206 | 90 | 1.4 | 155 | 60 | 1.2 | 61 | 40 | 0.6 |

### Example 7. Heat Stability of PDADMA/PSS PEC

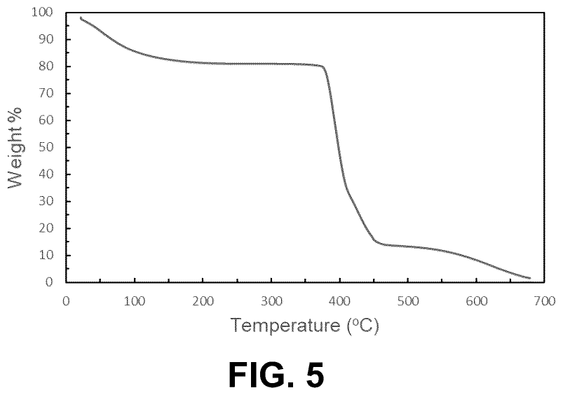

In order to be regenerated by heating the PDADMA/PSS PEC must remain stable at the regeneration temperature, typically 120° C. The graph below shows the weight of a sample of hydrated PDADMA/PSS PEC versus temperature. The weight loss at 120° C. indicates loss of water at the regeneration temperature. The weight remains constant up to 400° C., which means the material is thermally stable up to these temperatures. FIG. 5 shows the weight versus temperature for a hydrated PDADMA/PSS PEC. Water loss is complete by about 120° C. The material shows no further weight loss until 400° C.

### Example 8. Dust Test

To estimate the relative quantity of small particles, the vial was shaken after 3 days and the liquid above the desiccant was sampled then counted on the liquid scintillation counter. Any counts seen are from dust particles of desiccant (which contain labeled water). The PEC fiber produced the least dust (Table 5).

TABLE 5

| | Dust (ppm) | | |
|---|---|---|---|
| Desiccant | ACN | THF | Toluene |
| Mol Sieve | 2 | 6 | 0.1 |
| PEC fiber | 0.4 | 0.2 | 0.03 |
| Drierite | 21 | 19 | 0.7 |
| PEC powder | 107 | 88 | 1.6 |

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above compositions and processes without departing from the scope of the invention, it is intended that all matter contained in the above description and shown in the accompanying drawings shall be interpreted as illustrative and not in a limiting sense.

What is claimed:

1. An article comprising an anhydrous polyelectrolyte complex comprising an interpenetrating network of at least one positively charged polyelectrolyte polymer and at least one negatively charged polyelectrolyte polymer.

2. The article of claim 1, wherein the positively charged polyelectrolyte polymer comprises a plurality of quaternary ammonium groups covalently bonded to the positively charged polyelectrolyte polymer.

3. The article of claim 2, wherein the quaternary ammonium group comprises a nitrogen-bearing heteroaryl group, wherein nitrogen is alkylated.

4. The article of claim 2, wherein the quaternary ammonium group comprises a nitrogen-bearing cycloalkyl group, wherein nitrogen is alkylated.

5. The article of claim 4, wherein the nitrogen-bearing cycloalkyl group, is a four-to seven-member ring.

6. The copolymer of claim 2, wherein the quaternary ammonium group has the structure 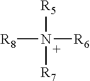
wherein R⁵ is an aryl group or an alkylene group and is covalently bonded to the polymer backbone, and R⁶, R⁷ and R⁸ are independently an alkyl group or an aryl group.

7. The article of claim 1, wherein the positively charged polyelectrolyte polymer comprises a protonated or alkylated poly(pyridine), a protonated or alkylated poly(imidazole), a protonated or alkylated a poly(piperidine), or a protonated or alkylated poly(amine).

8. The article of claim 1, wherein the positively charged polyelectrolyte polymer comprises poly(diallyldimethylammonium chloride) (PDADMA), poly(vinylbenzyltrimethylammonium) (PVBTA), ionenes, poly(acryloxyethyltrimethyl ammonium chloride), poly(methacryloxy(2-hydroxy)propyltrimethyl ammonium chloride), and copolymers thereof; polyelectrolytes comprising a pyridinium group such as poly(N-methylvinylpyridinium) (PMVP), including poly(N-methyl-2-vinylpyridinium) (PM2VP), and copolymers thereof; poly(allylaminehydrochloride) (PAH), polyvinylamine, polyethyleneimine (PEI); a polysulfonium, or a polyphosphonium.

9. The article of claim 1, wherein the negatively charged polyelectrolyte polymer comprises a plurality of sulfonate groups, carboxylate groups, phosphate groups, phosphonate groups, or any combination thereof covalently bonded to the negatively charged polyelectrolyte polymer.

10. The article of claim 1, wherein the negatively charged polyelectrolyte polymer comprises poly(styrenesulfonic acid) (PSS), poly(2-acrylamido-2-methyl-1-propane sulfonic acid) (PAMPS), sulfonated poly(ether ether ketone) (SPEEK), poly(ethylenesulfonic acid), poly(methacryloxyethylsulfonic acid, or a copolymer or salt thereof; poly(acrylic acid) (PAA), poly(methacrylic acid), or a copolymer or salt thereof; a polyphosphate, or a polyphosphonate.

11. The article of claim 1 wherein the positively charged polyelectrolyte polymer is poly(diallyldimethylammonium) and the negatively charged polyelectrolyte polymer is poly(styrene sulfonate).

12. The article of claim 1, wherein the polyelectrolyte complex further comprises an inorganic drying agent, a filler, a reinforcing agent, magnetic particles, a wet/dry indicator, or any combination thereof.

13. The article of claim 12, wherein the inorganic drying agent comprises a molecular sieve, calcium sulfate, silica, alumina, clay, calcium oxide, magnesium oxide, or any combination thereof.

14. The article of claim 1, wherein the article has a stored strain factor of at least about 2.

15. The article of claim 1, wherein when the polyelectrolyte complex is fully hydrated, the article has a glass transition temperature above 25° C. at or above room temperature.

16. The article of claim 1, wherein the anhydrous polyelectrolyte complex has a total percentage pore volume less than 10%.

17. The article of claim 1, wherein the anhydrous polyelectrolyte complex has a heat (enthalpy) of hydration of less than 0 kJ per mol.

18. The article of claim 1, wherein the article is a molded article or an extruded article.

19. The article of claim 1, wherein the article is produced by heating a hydrated polyelectrolyte complex comprising an interpenetrating network of at least one positively charged polyelectrolyte polymer and at least one negatively charged polyelectrolyte polymer at a temperature greater than 100° C. for a sufficient time to produce an anhydrous polyelectrolyte complex.

20. The article of claim 1, wherein the positively charged polyelectrolyte polymer and the negatively charged polyelectrolyte polymer are crosslinked with one another.
